(19) United States
(12) Patent Application Publication
(10) Pub. No.: US 2006/0059455 A1
(43) Pub. Date: Mar. 16, 2006

(54) Software development with review enforcement

(76) Inventors: Steven T. Roth, Sunnyvale, CA (US); Arun Girish Krishna, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/940,204

(22) Filed: Sep. 14, 2004

(51) Int. Cl. G06F 9/44

(52) U.S. Cl. 717/103; 717/120

(57) ABSTRACT

One embodiment disclosed relates to a method of validating a source code submission. A source code submission command, including at least one source code file, is received from a submitter. A check is made that the submitter has ownership authorization for each submitted source code file. Furthermore, verification is performed that review requirements for a valid submission are satisfied for each submitted source code file. Other embodiments are also disclosed.

### FIELD OF THE INVENTION

The present disclosure relates generally to computer software development.

### DESCRIPTION OF THE BACKGROUND ART

Proper coordination and management of teams of software engineers is desirable for efficient software development. When a group of engineers are working on a large number of different source modules of a software product, inefficiency and confusion can result if the development process and subsequent product release are not properly managed.

One aspect of managing the development process relates to controlling modifications made to the product source code. Typical source code development practices have a file-based ownership model. Each source file may have an owning team of developers, and its submittal to the source integration process requires one or more members of that team's permission. However, while the conventional source code ownership model provides some level of control over changes and updates to the product source code, applicants have determined that the ownership model is disadvantageously rudimentary and limited in its capabilities.

It is desirable to improve procedures and apparatus for software development. In particular, it is desirable to improve procedures and apparatus for controlling modifications made to product source code.

### SUMMARY

One embodiment of the invention pertains to a method of validating a source code submission. A source code submission command, including at least one source code file, is received from a submitter. A check is made that the submitter has ownership authorization for each submitted source code file. Furthermore, verification is performed that review requirements for a valid submission are satisfied for each submitted source code file.

Another embodiment pertains to a system for validating a source code submission. Computer-executable code is configured to receive a source code submission command, including at least one source code file, from a submitter. Computer-executable code is also configured to check that the submitter has ownership authorization for each submitted source code file and to verify that review requirements for a valid submission are satisfied for each submitted source code file.

Another embodiment pertains to an apparatus. The apparatus includes means for receiving a source code submission, including at least one source code file, from a submitter. The apparatus further includes means for verifying that review requirements for a valid submission are satisfied for each submitted source code file.

Another embodiment pertains to a software development system including at least a software configuration management system for managing source and objects code files and a review verification module for validating a source code submission to the software configuration management system. The review verification module is configured to receive a source code submission command, including at least one source code file, from a submitter, and is further configured to verify that review requirements for a valid submission are satisfied for each submitted source code file.

### BRIEF DESCRIPTION OF THE DRAWINGS

FIG. 1 shows a software development environment suitable for use in practicing an embodiment of the present invention.

FIG. 2 is a flow chart depicting a conventional process for submitting source code by a developer in accordance with embodiments of the invention.

FIG. 3A is a flow chart depicting a process for submitting source code by a developer in accordance with an embodiment of the invention.

FIG. 3B is a flow chart depicting a review enforcement procedure in accordance with an embodiment of the invention.

### DETAILED DESCRIPTION

As discussed above, the conventional file-based ownership model provides some level control over changes to product source code. Unfortunately, the conventional ownership model is limited to a single tier (single level) of control.

In some embodiments of the invention, a second tier (second level) of control is added. The second tier of control may, for example, utilize central review authorization over classes of files. As discussed further below, such central review authorization may advantageously be implemented using a review enforcement procedure.

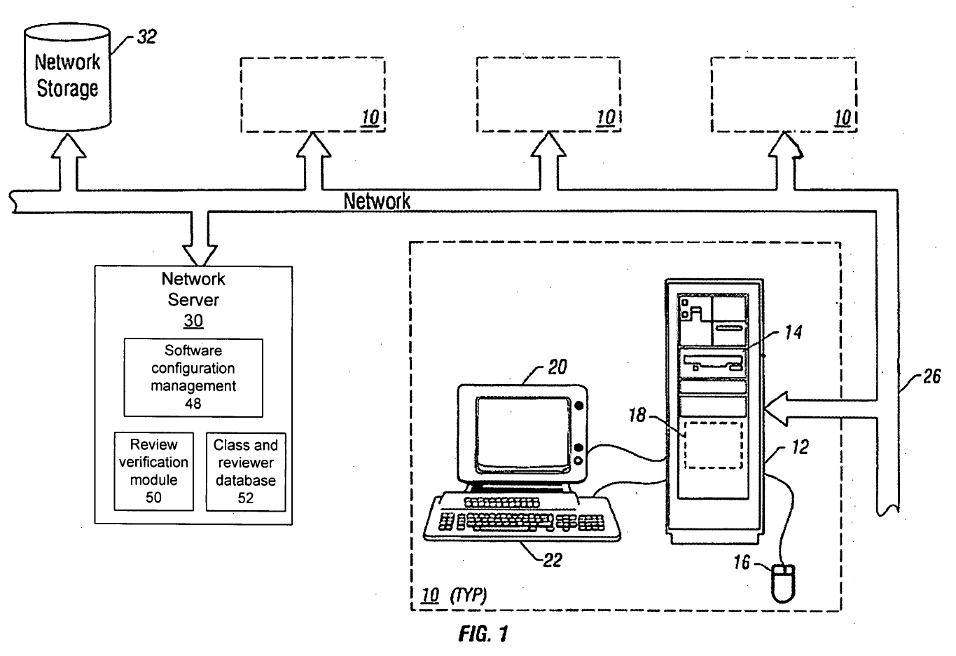

FIG. 1 shows a software development environment suitable for use in practicing an embodiment of the present invention. The software development environment may include a number of software development computer workstations 10 networked to a central network server 30 and a network storage medium 32 that includes a certain amount of quickly accessible electronic storage.

As shown in FIG. 1, the workstation 10 comprises a monitor 20 and keyboard 22, a computer processing unit 12, and various peripheral interface devices that might include a drive 14 for removable storage media and a mouse 16. Workstation 10 further includes memory 18 and a network interface 26 that interfaces the workstation to a number of other workstations, external network storage 32, and other external computing resources. The central network server 30 and network storage 32 together may comprise a file server and a software library archive that is managed by a software configuration management system 48.

In accordance with an embodiment of the invention, in addition to the software configuration management system 48, or as part of the software configuration management system 48, there is included a review verification module 50. The review verification module 50 advantageously provides a technique for enforcing source code review policies. The review verification module 50 may be implemented, for example, as a software script. In one implementation, the review verification module 50 may be configured to access a class and reviewer (class/reviewer) database 52. The class/reviewer database 52 is shown as residing at the network server 30, but other implementations may keep the review database 52 at other locations, such as the network storage 32. The class/reviewer database 52 may be configured to indicate the class of each source code file and also to indicate the oversight group, if any, required for each class. Each oversight group may include one or more reviewers. The operation of the review verification module 50 and its use of the class/reviewer database 52 are discussed further below.

Notwithstanding the above description of the software development environment, one skilled in the art will recognize that embodiments of the present invention can be practiced upon various specific physical configurations of standalone or networked software development workstations and may be utilized with various implementations of a software configuration management system.

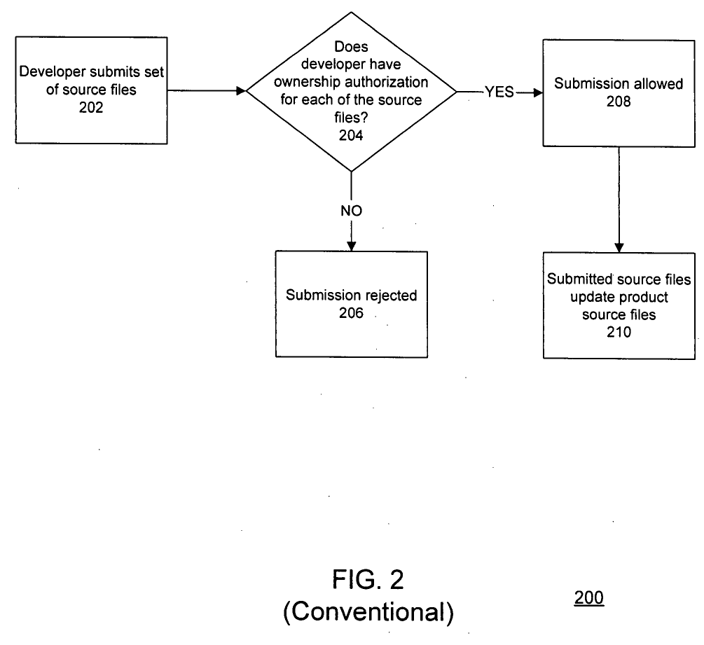

FIG. 2 is a flow chart depicting a conventional process (200) for submitting source code by a developer. The developer uses a command to submit (202) a set of source files to change or update the product source code.

Based on the submission, a determination (204) is made by the software configuration management system as to whether or not the submitter has ownership authorization for each of the source files. In other words, a determination is made as to whether the developer is among the owners for each of the source files submitted, or has been granted permission to submit the file by one of the owners of it. If not, then the submission is rejected (206) due to lack of ownership authority.

If the submitter has ownership authorization for each of the source files, then the submission is allowed (208). The submitted source files then update or change (210) the product source files.

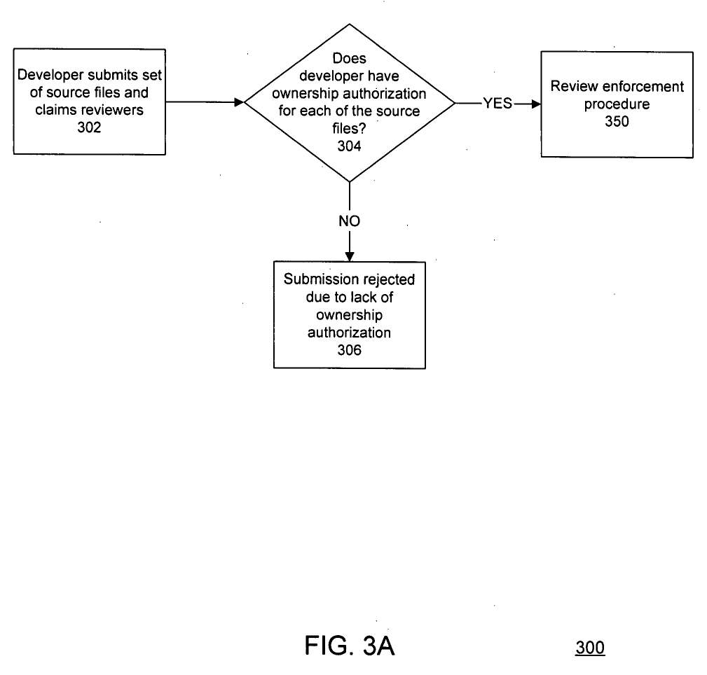

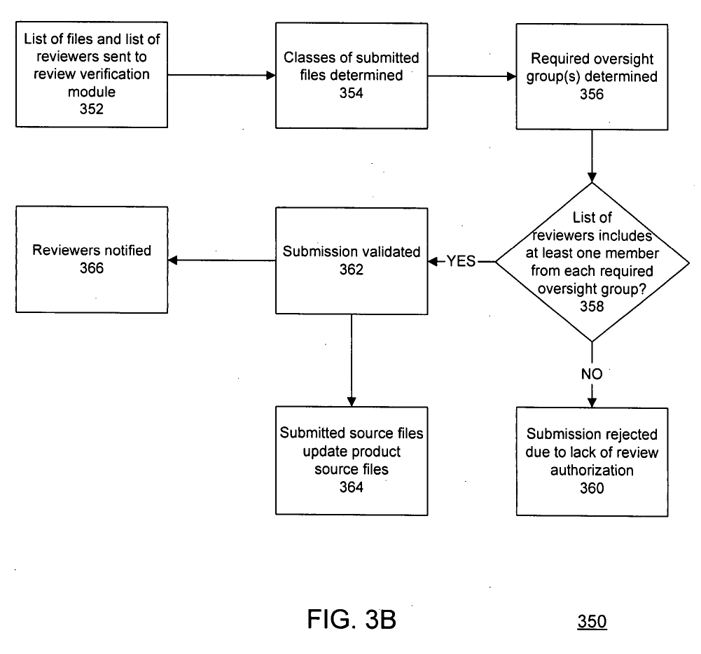

FIG. 3A is a flow chart depicting a process (300) for submitting source code by a developer in accordance with an embodiment of the invention. Here, the developer uses a submission command (302) that includes the set of source files to change or update the product source code and that also specifies those who reviewed the source code being submitted. The specified reviewers are those being claimed by the developer as having reviewed the source code files being submitted.

Like in the conventional technique, a determination (304) is made by the software configuration management system as to whether or not the submitter has ownership authorization for each of the source files. In other words, a determination is made as to whether the developer is among the owners for each of the source files submitted, or has been granted permission to submit the file by one of the owners of it. If not, then the submission is rejected (306) due to lack of ownership authority.

However, even if the submitter has ownership authorization for each of the source files, the submission is not yet authorized. In accordance with an embodiment of the invention, in order to become an authorized submission, a review enforcement procedure (350) is run and must be passed.

FIG. 3B is a flow chart depicting a review enforcement procedure (350) in accordance with an embodiment of the invention. The list of files and list of claimed reviewers from the developer may be sent (352) to the review verification module 50. In other words, the review verification module 50 processes the list of files and claimed reviewers.

The review verification module 50 may be configured to access the class/reviewer database 52 to a) determine (354) the classes of the submitted files and b) determine (356) the oversight groups, if any, required for those classes. Each oversight group may include one or more reviewers.

A determination (358) may be then made by the review verification module 50 as to whether the list of claimed reviewers includes at least one member from each required oversight group. If not, then the submission of source files is rejected (360) due to lack of review authorization.

If the list of claimed reviewers includes at least one member from each required oversight group, then the submission is validated (362) by the review verification module 50. The submitted source files then update or change (364) the product source files.

In addition, in accordance with an embodiment of the invention, communications may be sent to notify (366) the pertinent reviewers of the submission of source files. For example, the communications may be sent in the form of electronic mail messages to the reviewers including information on the submission. The information may include the developer and the list of source files submitted. In one implementation, the reviewers notified may include all reviewers claimed by the developer in the submission. In another implementation, the reviewers notified may be more narrowly defined. For example, the reviewers notified may include only those reviewers claimed by the developer that are members of the required oversight groups (and not those claimed reviewers who are not members of any required oversight group). In another implementation, the reviewers notified may be more broadly defined. For example, the reviewers notified may include all members of the required oversight groups.

In many circumstances, it is advantageous to have a second cross-functional tier of authorization that is separate from the code ownership. As described above, the second tier may be advantageously in the form of review authorization. Furthermore, the review authorization may be advantageously implemented with review enforcement mechanisms.

The present application describes a type of submittal validation script (or module). The submittal validation script is configured to check every submission to the main integration branches. The script examines each submission to see whether that submittal includes a change to a source file belonging to a class of files requiring oversight. If so, the script examines the submittal contents to see whether the submitter claims that the submission was reviewed by one of the central authorities (reviewers) for that class. If the submission includes a file requiring oversight, but it has not been reviewed by one of the pertinent central authorities, then the submission is rejected.

In one specific implementation, this technique may be applied to allow a select design team to act as central authorities over module metadata files. The technique may also be used in various other contexts, such as a central authority over makefiles, and so on.

In relation to one aspect of the above-discussed technique, the technique relies on the submitter's claims of who reviewed the submittal. It is possible for the submitter to claim falsely that one of the central authorities has reviewed a change. Various mechanisms are possible to prevent or mitigate such a false claim. As discussed above, one mechanism automatically generates and sends an electronic mail message to the purported reviewers showing the submittal, or at least showing the claim of review. Then, if the claim were false, the reviewer could take steps to block the submittal or censure the submitter. More secure mechanisms are also contemplated. For example, each claimed reviewer may be required to verify his/her review of the submittal prior to the submission being authorized. Various other mechanisms may also be used.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of validating a source code submission, the method comprising:
receiving a source code submission command, including at least one source code file, from a submitter;
checking that the submitter has ownership authorization for each submitted source code file; and
verifying that review requirements for a valid submission are satisfied for each submitted source code file.

2. The method of claim 1, wherein said verifying includes determining classes of the submitted source code files.

3. The method of claim 2, wherein said verifying further includes determining oversight groups required by the classes.

4. The method of claim 3, wherein the source code submission further includes a list of claimed reviewers, and wherein said verifying further includes determining whether the list of reviewers includes at least one member from each required oversight group.

5. The method of claim 4, further comprising:
rejecting the submission if the list of reviewers does not include at least one member from each required oversight group.

6. The method of claim 4, further comprising:
validating reviewer authorization of the submission if the list of reviewers includes at least one member from each required oversight group.

7. The method of claim 4, further comprising:
notifying pertinent reviewers of the submission.

8. The method of claim 7, wherein the notification is sent via electronic mail.

9. The method of claim 7, wherein the pertinent reviewers include those claimed reviewers that are members of a required oversight group.

10. The method of claim 4, further comprising:
obtaining confirmation from pertinent reviewers prior to validating reviewer authorization of the submission.

11. A system for validating a source code submission, the system comprising:
computer-executable code configured to receive a source code submission command, including at least one source code file, from a submitter;
computer-executable code configured to check that the submitter has ownership authorization for each submitted source code file; and
computer-executable code configured to verify that review requirements for a valid submission are satisfied for each submitted source code file.

12. The system of claim 11, wherein said verifying includes determining classes of the submitted source code files.

13. The system of claim 12, wherein said verifying further includes determining oversight groups required by the classes.

14. The system of claim 13, wherein the source code submission further includes a list of claimed reviewers, and wherein said verifying further includes determining whether the list of reviewers includes at least one member from each required oversight group.

15. The system of claim 14, further comprising:
computer-executable code configured to reject the submission if the list of reviewers does not include at least one member from each required oversight group.

16. The system of claim 14, further comprising:
computer-executable code configured to validate reviewer authorization of the submission if the list of reviewers includes at least one member from each required oversight group.

17. The system of claim 14, further comprising:
computer-executable code configured to notify pertinent reviewers of the submission.

18. The system of claim 17, wherein the notification is sent via electronic mail.

19. The system of claim 17, wherein the pertinent reviewers include those claimed reviewers that are members of a required oversight group.

20. The system of claim 14, further comprising:
computer-executable code configured to obtain confirmation from pertinent reviewers prior to validating reviewer authorization of the submission.

21. An apparatus comprising:
means for receiving a source code submission, including at least one source code file, from a submitter; and
means for verifying that review requirements for a valid submission are satisfied for each submitted source code file.

22. The apparatus of claim 21, wherein said verifying includes determining classes of the submitted source code files and determining oversight groups required by the classes.

23. The apparatus of claim 22, wherein the source code submission further includes a list of claimed reviewers, and wherein said verifying further includes determining whether the list of reviewers includes at least one member from each required oversight group.

24. A software development system configured to validate a source code submission, the software development system comprising:
a software configuration management system for managing source and objects code files; and
a review verification module for validating a source code submission to the software configuration management system,
wherein the review verification module is configured to receive a source code submission command, including at least one source code file, from a submitter, and is further configured to verify that review requirements for a valid submission are satisfied for each submitted source code file.

25. The software development system of claim 24, wherein said verifying includes determining classes of the submitted source code files and determining oversight groups required by the classes.

26. The software development system of claim 25, wherein the source code submission further includes a list of claimed reviewers, and wherein said verifying further includes determining whether the list of reviewers includes at least one member from each required oversight group.

27. A computer-readable storage medium comprising:
computer-readable code configured to receive a source code submission, including at least one source code file, from a submitter;
computer-readable code configured to check that the submitter has ownership authorization for each submitted source code file; and
computer-readable code configured to verify that review requirements for a valid submission are satisfied for each submitted source code file.

28. The computer-readable storage medium of claim 27, wherein said code configured to verify includes code configured to determine classes of the submitted source code files and code configured to determine oversight groups required by the classes.

29. The computer-readable storage medium of claim 28, wherein the source code submission further includes a list of claimed reviewers, and wherein said code configured to verify further includes code configured to determine whether the list of reviewers includes at least one member from each required oversight group.
